(19) United States
(12) Patent Application Publication
(10) Pub. No.: US 2013/0052611 A1
(43) Pub. Date: Feb. 28, 2013

(54) COUPLING DEVICE BETWEEN A MOTOR AND A HANDPIECE FOR DENTAL OR SURGICAL USE

(71) Applicants: Edgar Schoenbaechler, Neuchatel (CH); Didier Siegenthaler, Cornaux (CH)

(72) Inventors: Edgar Schoenbaechler, Neuchatel (CH); Didier Siegenthaler, Cornaux (CH)

(21) Appl. No.: 13/697,245

(22) PCT Filed: May 10, 2011
(86) PCT No.: PCT/EP2011/057460

§ 371 Date: Nov. 9, 2012

(30) Foreign Application Priority Data
May 12, 2010 (EP) 10162732.1

(51) Int. Cl. A61C 1/06; H02K 7/14

(52) U.S. Cl. 433/131; 310/50

(57) ABSTRACT

A coupling device between a motor and a handpiece for dental or surgical use. An electric motor includes a nozzle for coupling to the surgical or dental handpiece, and the ratio between the length of the coupling nozzle and the external diameter of the coupling nozzle set by ISO standard 3964-1982 is between 1.8 and 2.5. The handpiece for surgical or dental use is adapted to receive the shortened coupling nozzle of the electric motor. An assembly can be formed by the handpiece and the electric motor of this type.

The present invention concerns a coupling device between a motor and a handpiece for dental or surgical use. More specifically, the present invention concerns a coupling device of this type with optimised ergonomics.

Dental surgeries have considerably developed over the last few years. In order to provide their clients with a complete service in comforting and modern surroundings, practitioners invest in more and more sophisticated equipment. Faced with increasingly diverse operations (restoration, endodontics, prophylaxis, orthodontics, implants, etc.), the number of the practitioner's instruments has considerably increased. The work space of the practitioner is, however, necessarily limited. All the instruments necessary for the treatment must be grouped around the patient seated in the chair and they must remain within the practitioner's reach. The instruments must be able to be changed quickly during a treatment and between two successive patients. Moreover, the instruments must be able to be controlled simply and in conditions of impeccable hygiene to avoid any risk of error in handling or of contamination.

Further, an increasing number of dental clinics are being set up in which several practitioners share equipment in order to offer a complete service. Thus, there is an endlessly increasing need for versatile work tools which can be used in an extremely flexible way by different people.

With the electrification of supply and control units, commonly known as “units”, the electric motor coupled to a handpiece offers a broad range of speeds at high power and has largely replaced instruments operating with compressed air. Most frequently, the electric motor is fitted to the unit in a semi-permanent manner and has a mechanical interface at the front thereof for assembling and changing handpieces quickly.

For many years and for the vast majority of products on the market, the coupling device between an electric motor and a handpiece meet the criteria of ISO standard 3964-1982. This standard, which came into force in 1982, governs the mechanical dimensions of the coupling and the application thereof by most manufacturers allows practitioners to use products of different brands freely without worrying about the compatibility of the motors and handpieces.

The coupling device between an electric motor and a handpiece also ensures the passage of fluids, particularly air and water, in separate channels to create a spray in the work area of the tool. Coupling devices allowing the passage of air and water are disclosed in CH Patent Nos. 621057 and 580420 filed in the 1970s. These coupling devices, which were marketed with the registered trademarks Intramatic® and Intramatic® Lux, quickly took over the market and still today represent a kind of standard.

Finally, light, conventionally produced by a bulb in the motor for lighting the work area, is brought via an optical fibre arranged inside the handpiece. The light passes from the motor to the handpiece around the aforementioned coupling device.

Currently, it appears that the interfaces of the type described above no longer satisfy changing requirements, particularly in terms of ergonomics, handling, lightness and performance. In particular, the feminisation of the profession has revealed a need for shorter instruments better adapted to generally smaller hands.

It is an object of the present invention to respond to this need in addition to others by providing a coupling device between a motor and a handpiece for dental or surgical use with optimised ergonomics.

The present invention therefore concerns an electric motor having a nozzle for coupling to a surgical or dental handpiece, the ratio between the length of the nozzle and the external diameter of the nozzle set by ISO standard 3964-1982 being comprised between 1.8 and 2.5.

Owing to these features, the present invention provides an electric motor for a dental or surgical handpiece wherein the length of the nozzle is comprised within a range varying from 17 to 25 mm. This range of values is to be compared to the nozzle length of 31.8 mm resulting from ISO standard 3964-1982.

The inventive merit of the present invention is having demonstrated that a substantial reduction in the length of the nozzle of an electric motor for a surgical or dental handpiece is not detrimental to the mechanical properties of the coupling between the motor and the handpiece. On the contrary, it has been observed that, despite the reduction in the motor nozzle length, it is possible to guarantee the same performance in terms of mechanical properties, coupling, and the guiding and transmission of mechanical power. The inventive merit of the invention is even greater in that it is proposed to modify the value of a parameter, in this case the nozzle length of an electric motor, with which all manufacturers have complied for 30 years, i.e. since the publication of ISO standard 3964-1982 in 1982.

According to another advantage of the invention, the reduction in the electric motor nozzle length does not affect the rear portion of the coupling, so that the axial locking means between the electric motor and the handpiece and the geometry of the passage of air/water fluids and light flow remain unchanged. It is thus possible to guarantee the compatibility of motors with a shortened nozzle according to the invention and existing handpieces on the market originally intended to be fitted to a motor conforming to ISO standard 3964-1982.

According to yet another advantage of the invention, the reduction in the electric motor nozzle length relative to the requirement of ISO standard 3964-1082 does not affect the coupling mechanism between the electric motor and the handpiece. The ISO standard 3964-1982 compliant coupling enables the handpiece to be connected to the motor nozzle and the handpiece to be axially locked on the motor nozzle regardless of the angular position of the two parts of the coupling which are called the driver and driven parts and are respectively located in the motor and handpiece. If the two coupling parts, namely the driving and driven parts, are in a relative angular position which does not allow them to be coupled, the driven part, which is mounted on a spring, absorbs the axial movement from the driving part of the motor during connection. As a result, the coupling operates immediately and automatically and the driven part returns to its original axial position. It will also be noted that, by virtue of its design, the mechanism described above also compensates for axial alignment errors between the motor and the handpiece.

The present invention also concerns a surgical or dental handpiece including a female rear portion intended to receive the coupling nozzle of an electric motor, the length of which is comprised between 17 and 25 mm, the length of the female rear portion being reduced in the same proportions as the motor nozzle.

By reducing the length of the electric motor coupling nozzle, it is thus possible to reduce the length of the handpiece in the same proportions, which allows the total length of the motor/handpiece assembly to be reduced. The motor/handpiece assembly is thus lighter and can be gripped better.

According to a complementary feature of the invention, the length of the female rear portion is at least 17 mm, tolerances being taken into account.

Finally, the present invention concerns an assembly formed by an electric motor and a surgical or dental handpiece, wherein the electric motor includes a nozzle for the coupling to the surgical or dental handpiece. Since the ratio between the length of the nozzle and the external diameter of the nozzle set by ISO standard 3964-1982 is comprised between 1.8 and 2.5, the length of the female rear portion of the handpiece intended to receive the motor nozzle is reduced in the same proportions as the motor nozzle.

Other features and advantages of the present invention will appear more clearly from the following detailed description of an embodiment of the coupling device according to the invention, this example being given solely by way of non-limiting illustration with reference to the annexed drawing, in which:

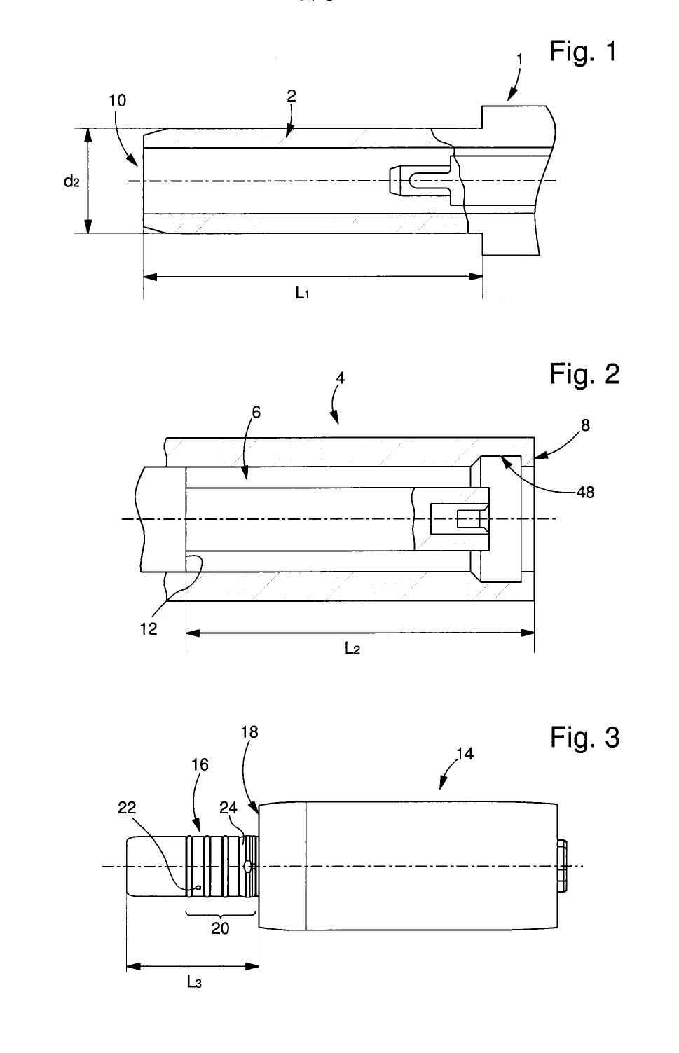

FIG. 1 is a partial cross-section of the coupling nozzle of an electric motor for a dental or surgical handpiece which complies with ISO standard 3964-1982.

FIG. 2 is a cross-section of the female coupling portion of a surgical or dental handpiece which complies with ISO standard 3964-1982.

FIG. 3 is a side view of an electric motor for a surgical or dental handpiece according to the invention.

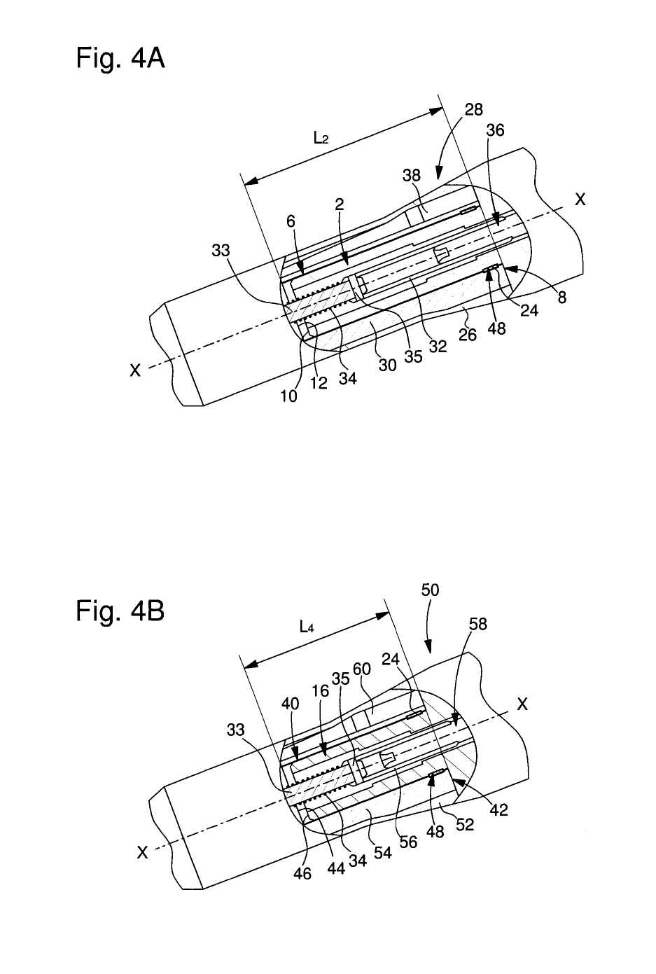

FIG. 4A is a side view with material torn away from the coupling area between a handpiece and an electric motor in conformity with ISO standard 3964-1982.

FIG. 4B is a side view with material torn away from the coupling area between a shortened handpiece and electric motor according to the present invention.

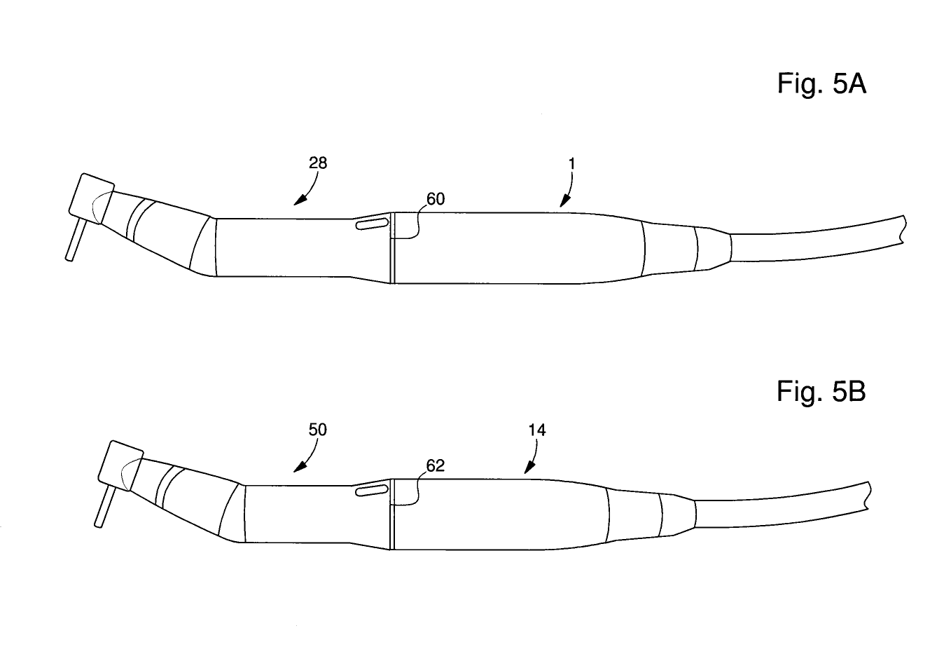

FIG. 5A is a side view of the assembly formed by an electric motor and a handpiece which complies with ISO standard 3964-1982.

FIG. 5B is a side view of an assembly formed by an electric motor and a handpiece according to the invention.

The present invention proceeds from the general inventive idea which consists in reducing the length of the coupling nozzle of an electric motor for a surgical or dental handpiece from a value of 31.8 mm set by international ISO standard 3964-1982 to a value comprised between 17 and 25 mm. In doing so, the present invention proposes to modify the value of a parameter with which all manufacturers have complied for 30 years, i.e. since the publication of ISO standard 3964-1982 in 1982. The inventive merit of the present invention is even greater in that it demonstrates that, despite a substantial reduction in the length of the motor coupling nozzle, it is possible to guarantee the same performance in terms of mechanical properties, coupling, and guiding and transmitting mechanical power as the coupling nozzle of an electric motor that complies with the criteria of ISO standard 3964-1982. Finally, the reduction in motor nozzle length according to the invention does not affect the means for axially locking the electric motor and the handpiece or the geometry of the passage of air/water fluids and light flow. It is thus possible to guarantee the compatibility of motors with a shortened nozzle according to the invention and existing handpieces on the market originally intended to be fitted to a motor conforming to ISO standard 3964-1982.

FIG. 1 is a partial cross-section of an electric motor for a dental or surgical handpiece compliant with ISO standard 3964-1982. Designated as a whole by the general reference numeral 1, this electric motor includes a coupling nozzle 2, the external diameter d₂ of which has a nominal dimension of 9.86 mm and the overall length L₁ of which is 31.8 mm.

FIG. 2 is a cross-section of the female coupling portion of a surgical or dental handpiece which complies with ISO standard 3964-1982.

Designated as a whole by the general reference numeral 4, this female coupling portion defines a cylindrical housing 6 for receiving coupling nozzle 2 of electric motor 1. The length L₂ comprised between the entry face 8 of the female coupling portion 4 of the handpiece against which the electric motor 1 abuts and a circular shoulder 12, located at the bottom of cylindrical housing 6, is equal to 32 mm. Thus, tolerances being taken into account, length L₂ of cylindrical housing 6 is equal to the overall length L₁ of coupling nozzle 2 of electric motor 1.

FIG. 3 is a side view of an electric motor for a surgical or dental handpiece according to the invention. Designated as a whole by the general reference numeral 14, this motor has a coupling nozzle 16 which is connected to the frame of motor 14 by a circular shoulder 18. The length L₃ of coupling nozzle 16 is shortened, solely by way of non-limiting example, by approximately 10 mm compared to the length of coupling nozzle 2 of a motor 1 compliant with ISO standard 3964-1982. The length of shortened coupling nozzle 16 according to the invention is thus approximately 22 mm, tolerances being taken into account.

On the proximal portion 20 of shortened coupling nozzle 16, an air passage 22 can be seen (the second passage for water is not visible in the drawing) and a ring 24 for axially locking a handpiece which will be described in detail below. These water/air passages and the axial locking ring form an interface of the type marketed under the registered trademark Intramatic® which is still considered today to be a kind of standard.

FIGS. 4A and 4B are side views with material torn away from the coupling area between a handpiece and an electric motor conforming to ISO standard 3964-1982 and respectively between a shortened handpiece and electric motor according to the present invention.

FIG. 4A shows that the external sheath 26 of handpiece 28 encloses a support-piece 30 of generally cylindrical shape which defines a cylindrical housing 6 for receiving the coupling nozzle 2 of an electric motor 1 compliant with ISO standard 3964-1982.

A driven part 32 is centred on the longitudinal axis of symmetry X-X of handpiece 28. This driven part 32 is rigidly coupled to a shaft 33 via a pin 35. A spring 34 fitted onto driven shaft 33 allows driven part 32 a certain axial play in the event of axial misalignment with a driving shaft 36 of electric motor 1. This driving shaft 36 communicates the motor torque produced by electric motor 1 to the driven part 32, at the end of which a work tool such as a grinding tool (not shown) is mounted. Finally, an optical fibre 38 brings light towards the work area.

FIG. 4A shows the length L₂ of cylindrical housing 6 for receiving coupling nozzle 2 of electric motor 1. It will be recalled that this length is 32 mm and matches the overall length L₁, tolerances being taken into account, of coupling nozzle 2 of electric motor 1 compliant with ISO standard 3964-1982.

FIG. 4B is a similar view to that of FIG. 4A illustrating the coupling between a motor with a shortened nozzle and a handpiece according to the invention. It is noted that the views of FIGS. 4A and 4B are drawn with the same scale of reduction, which means that the saving in length obtained as a result of the invention can be immediately appreciated. Indeed, assuming purely for illustrative and non-limiting purposes, that it is decided to shorten the length of the coupling nozzle of an electric motor compliant with ISO standard 3964-1982 by 10 mm, the length of the shortened coupling nozzle 16 according to the invention is approximately 22 mm, tolerances being taken into account. Consequently, the length L₄ of cylindrical housing 40 for receiving the shortened coupling nozzle 16 of electric motor 14 according to the invention is approximately 23 mm. This length L₄ is included between the entry face 42 of cylindrical housing 40 against which electric motor 14 abuts via the circular shoulder 18 thereof, and a circular shoulder 44 located at the bottom of cylindrical housing 40. A certain play of around 1 mm is provided between the front face 46 of coupling nozzle 16 of electric motor 14 and the circular shoulder 44 at the bottom of cylindrical housing 40 to enable the axial locking ring 24 to snap into a groove 48 provided at the back of handpiece 50.

To achieve this result, a certain number of components of handpiece 50 according to the invention have to be shortened. This concerns the external sheath 52 of support-piece 54 which defines the cylindrical housing 40 for receiving shortened coupling nozzle 16 of electric motor 14 according to the invention, and driven part 56 which is rigidly coupled to shaft 33 via pin 35 and which is for receiving the motor torque produced by electric motor 14, via a drive shaft 58. Optical fibre 60 is also shortened.

It is clear from the foregoing that shortening the coupling nozzle of the motor according to the invention does not involve modifying the proximal portion 20 of coupling nozzle 16, so that the axial locking between the motor and a handpiece and geometry of the passages of fluids and light flow are not affected. It is therefore possible for a motor with a shortened nozzle according to the invention to remain compatible with existing handpieces on the market.

It is also clear that shortening the coupling nozzle of the electric motor is accompanied by a corresponding shortening of the handpiece. According to the invention, the length of the coupling nozzle is reduced from 31.8 mm to a value comprised between 17 and 25 mm and the length of the cylindrical housing defined by the female coupling portion of the handpiece for receiving the shortened coupling nozzle of the electric motor according to the invention is reduced in the same proportions as the coupling nozzle.

The decrease in length obtained as a result of the present invention can be visually appreciated in FIGS. 5A and 5B which are drawn on the same scale.

FIG. 5A is a side view of an assembly formed by an electric motor 1 and a handpiece 28, both of which conform to ISO standard 3964-1982.

FIG. 5B is a side view of an assembly formed by an electric motor 14, whose coupling nozzle (not visible in the drawing) is shortened and a handpiece 50, the length of which is reduced in the same proportions as the shortened coupling nozzle of electric motor 14 according to the invention.

The fact that, in FIGS. 5A and 5B, the areas of connection 62 and 64 between electric motor 1 and 14 respectively and handpiece 28 and 50 respectively are aligned, means that the saving in length obtained as a result of the invention can be immediately appreciated.

It goes without saying that this invention is not limited to the embodiment that has just been described and that various simple alterations and variants can be envisaged by those skilled in the art without departing from the scope of the invention as defined by the claims annexed to this Patent Application. The present invention provides numerous advantages, amongst which the following can be cited:
a reduction in weight due to the shortening of the coupling, since the total length of the motor/handpiece assembly is reduced while guiding performance in terms of mechanical properties, reliability and tolerances is maintained;
a forward movement of the centre of gravity of the motor/handpiece assembly which considerably improves the hold of the instrument and makes work less tiring because of optimised ergonomics;
a more compact grip and an improvement in the balance of the motor/handpiece assembly;
a reduction in the manufacturing cost and the raw material necessary to manufacture the motor;
improved shock resistance, particularly in the event of a fall;
guaranteed compatibility between existing dental handpieces and motors with a shortened nozzle according to the invention. Indeed, the vast majority of existing instruments conform with ISO standard 3964-1982 and can be perfectly well connected with no loss of performance to a motor with a short nozzle;
a decrease in light transmission losses in the optical fibre of the contra-angle handpiece.

1-6. (canceled)

7. An electric motor comprising:
a nozzle for coupling to a surgical or dental handpiece,
wherein the ratio between the length of the coupling nozzle and the external diameter of the coupling nozzle set by ISO standard 3964-1982 and equal to 9.86 mm is between 1.8 and 2.5, so that the length of the coupling nozzle is between 17 and 25 mm.

8. A surgical or dental handpiece comprising:
a female rear portion defining a cylindrical housing for receiving a coupling nozzle of an electric motor, the length of which is between 17 and 25 mm,
wherein the length of the cylindrical housing is reduced in same proportions as the length of the coupling nozzle of the motor and is at least 17 mm.

9. The handpiece according to claim 8, wherein the length of the cylindrical housing has a play of 1 mm relative to the length of the coupling nozzle of the electric motor.

10. The handpiece according to claim 8, wherein the length of the cylindrical housing for receiving the coupling nozzle of the electric motor is between an entry face of the cylindrical housing and a circular shoulder located on a bottom of the cylindrical housing, a front face of the coupling nozzle of the electric motor exhibiting play with the circular shoulder at the bottom of the cylindrical housing to allow an axial locking ring to snap into a groove provided at a rear of the handpiece.

11. The handpiece according to claim 9, wherein the length of the cylindrical housing for receiving the coupling nozzle of the electric motor is between an entry face of the cylindrical housing and a circular shoulder located on a bottom of the cylindrical housing, a front face of the coupling nozzle of the electric motor exhibiting play with the circular shoulder at the bottom of the cylindrical housing to allow an axial locking ring to snap into a groove provided at a rear of the handpiece.

12. An assembly comprising:
an electric motor and a handpiece for surgical or dental use,
wherein the electric motor comprises a nozzle for coupling to the handpiece, the ratio between the length of the coupling nozzle and the external diameter of the coupling nozzle set by ISO standard 3964-1982 is between 1.8 and 2.5, so that the length of the coupling nozzle is between 17 and 25 mm,
the length of a cylindrical housing of the handpiece for receiving the coupling nozzle of the electric motor is reduced in same proportions as the coupling nozzle of the electric motor and is at least 17 mm.

13. An assembly according to claim 12, wherein the length of the cylindrical housing has a play of 1 mm relative to the length of the coupling nozzle of the electric motor.
